(19) United States
(12) Patent Application Publication
(10) Pub. No.: US 2013/0342703 A1
(43) Pub. Date: Dec. 26, 2013

(54) System and Method for Identifying Human Face

(71) Applicant: PSP Security Co., Ltd., Taipei City (TW)

(72) Inventor: Fan-Sheng Lin, Taipei City (TW)

(21) Appl. No.: 13/914,694

(22) Filed: Jun. 11, 2013

(30) Foreign Application Priority Data
Jun. 25, 2012 (TW) 101122669

(51) Int. Cl. H04N 5/33; G06K 9/00

(52) U.S. Cl. CPC H04N 5/33; G06K 9/00228
USPC 348/164; 382/103

(57) ABSTRACT

The present invention discloses a system for identifying a human face, which includes a visible light camera, an infrared (IR) camera, a non-contact temperature sensing device and a processing unit. The visible light camera and the IR camera aim at a same photograph zone for respectively photographing at least one visible-light picture and at least one IR picture. The non-contact temperature sensing device senses a present target temperature in a temperature sensing zone, which is in the photograph zone. When the processing unit detects that a human face is existed in the corresponding zone of the visible-light picture and that of the IR picture, it determines if the present target temperature is in a body-temperature range. When the present target temperature is in the body-temperature range, the processing unit determines that the human face detected in the corresponding zone is an alive human face.

### RELATED APPLICATIONS

This application claims priority to Taiwanese Application Serial Number 101122669, filed Jun. 25, 2012, which is herein incorporated by reference.

### BACKGROUND

1. Technical Field

The present invention relates to a system and method for identifying a human face.

2. Description of Related Art

Since a human face is one of the important bio-features of human beings, many researches are devoted to the study of the human face. Among which, facial identification through computer to analyze visible characteristics of a human face is an important application. Access control may be applied based on the facial identification, which saves the cost of using proximity cards and avoid the inconvenience of bring the proximity cards. Compared with other bio-feature identification methods, facial identification, which is performed from distance without contact, is acceptable for most of the people. In particular, the benefit of the facial identification shows when both hands are not available for security cards or inputting passwords.

Another important research about human face is human-face detection. When it is detected that a suspicious moving object enters into a monitoring area of a surveillance camera, the human-face detection may be triggered to focus on such suspicious moving object and determine if it is an intruder.

However, with the advent of Internet and social networks, pictures and videos with personal faces can be retrieved easily. In addition, as the technology for output units (such as printers, screens, etc.) rapidly improves, pictures and videos can be output in high quality and resemblance to the real human face. As a result, a human face identification or detection system may be easily deceived by such pictures or videos in high quality and resemblance.

### SUMMARY

According to one embodiment of this invention, a system for identifying a human face is disclosed to perform an alive human-face determination utilizing at least one visible-light picture, at least one infrared (IR) picture and a present target temperature. The system for identifying a human face includes a visible light camera, an IR camera, a non-contact temperature sensing device and a processing unit. The processing unit builds connections with the visible light camera, the IR camera and the non-contact temperature sensing device. The visible light camera photographs at least one visible-light picture. The IR camera photographs at least one IR picture. Wherein, the visible light camera and the IR camera aim at a same photograph zone for respectively photographing the visible-light picture and the IR picture. The non-contact temperature sensing device senses a present target temperature in a temperature sensing zone. Wherein, the temperature sensing zone is in the photograph zone. The processing unit includes a face detecting module and a body-temperature determining module. The face detecting module detects if a human face is existed in a corresponding zone corresponding to the temperature sensing zone of the visible-light picture and that of the IR picture respectively. When it is detected that a human face is existed in the corresponding zone of the visible-light picture and that of the IR picture, the body-temperature determining module determines if the present target temperature is in a body-temperature range. When the present target temperature is in the body-temperature range, the processing unit determines that the human face detected in the corresponding zone is an alive human face.

According to another embodiment of this invention, a method for identifying a human face is disclosed to perform an alive human-face determination utilizing at least one visible-light picture, at least one IR picture and a present target temperature. The method for identifying a human face includes the following steps:

(a) receiving at least one visible-light picture and at least one IR picture, which are photographed at a same photograph zone;

(b) receiving a present target temperature in a temperature sensing zone, which is in the photograph zone;

(c) detecting if a human face is existed in a corresponding zone corresponding to the temperature sensing zone of the visible-light picture and that of the IR picture respectively;

(d) when it is detected that a human face is existed in the corresponding zone of the visible-light picture and that of the IR picture, determining if the present target temperature is in a body-temperature range; and

(e) when the present target temperature is in the body-temperature range, determining that the human face detected in the corresponding zone is an alive human face.

The present invention can achieve many advantages. Pictures with human faces, human faces displayed on display units, human-face masks or other methods for faking human faces would not be determined as alive human faces. In addition, only one single visible picture and one single IR picture are needed for an alive-human-face determination, which can speed up identification efficiency.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 illustrates a block diagram of a system for identifying a human face according to an embodiment of this invention;

FIG. 2 shows an embodiment of a photograph zone and a temperature sensing zone;

FIG. 3 shows human-face detection results utilizing the hardware units of the system 100 for identifying a human face applying to different scenarios; and

FIG. 4 is a flow diagram of a method for identifying a human face according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

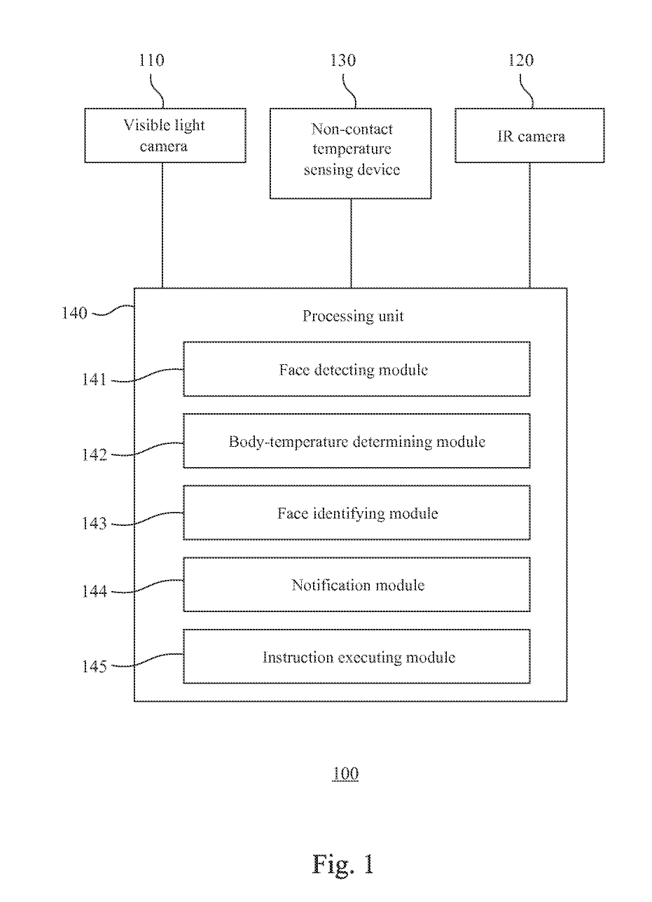

FIG. 1 illustrates a block diagram of a system for identifying a human face according to an embodiment of this invention. The system for identifying a human face performs an alive human-face determination utilizing at least one visible-light picture, at least one infrared (IR) picture and a present target temperature.

The system 100 for identifying a human face includes a visible light camera 110, an IR camera 120, a non-contact temperature sensing device 130 and a processing unit 140. The non-contact temperature sensing device 130 may be an IR thermometer or any other type of non-contact temperature sensing device. The processing unit 140 may be provided by a computer, a server, any other type of electrical device or combination thereof. The processing unit 140 builds connections with the visible light camera 110, the IR camera 120 and the non-contact temperature sensing device 130 through a wired or wireless data transmission interface.

The visible light camera 110 photographs at least one visible-light picture. The IR camera 120 photographs at least one IR picture. Wherein, the visible light camera 110 and the IR camera 120 aim at a same photograph zone for respectively photographing the visible-light picture and the IR picture at exactly or almost the same time. In some embodiments of this invention, a visible light and an IR light may be shone on the photograph zone, such that the visible light camera 110 and the IR camera 120 can photograph clear pictures.

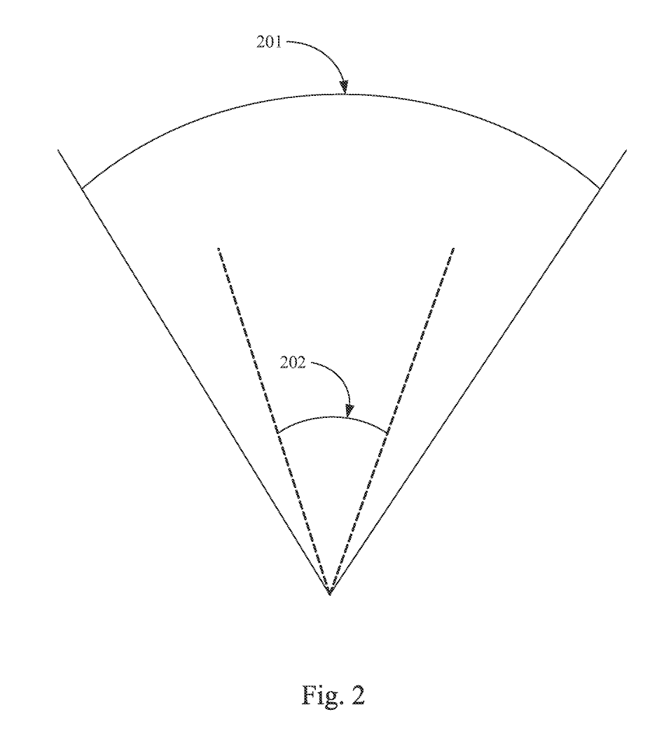

The non-contact temperature sensing device 130 senses a present target temperature in a temperature sensing zone. Wherein, the temperature sensing zone (as the zone 202 in FIG. 2) is in the photograph zone(as the zone 201 in FIG. 2). In addition, the present target temperature is sensed at exactly or almost the same time with the photograph of the visible-light picture and the IR picture. In some embodiments of this invention, the visible light camera 110, the IR camera 120 and the non-contact temperature sensing device 130 may be synchronized for performing photographing or sensing at the same time.

The processing unit 140 includes a face detecting module 141 and a body-temperature determining module 142. The face detecting module 141 detects if a human face is existed in a corresponding zone corresponding to the temperature sensing zone of the visible-light picture and that of the IR picture respectively. In some embodiments of this invention, the face detecting module 141 may perform a human-face detecting algorithm or a human-face identifying algorithm to detect if a human face is existed in the corresponding zone of the pictures. In some other embodiments, the face detecting module 141 may perform a skin-color detection to the corresponding zone corresponding to the temperature sensing zone of the visible-light picture for determining if a skin color zone which may be taken as a human face is existed in the corresponding zone. Hence, when the face detecting module 141 detects that a human face is existed in the corresponding zone of the visible-light picture and that of the IR picture, the body-temperature determining module 142 determines if the present target temperature is in a body-temperature range.

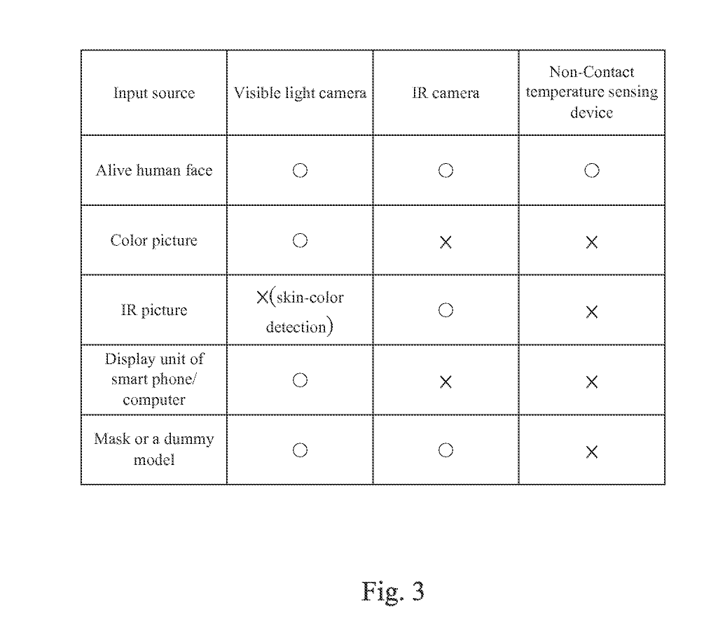

When the body-temperature determining module 142 determines that the present target temperature is in the body-temperature range, the processing unit 140 determines that the human face detected in the corresponding zone is an alive human face. Therefore, pictures with human faces, human faces displayed on display units, human-face masks or other methods for faking human faces would not be determined as alive human faces. In addition, only one single visible picture and one single IR picture are needed for an alive-human-face determination, which can speed up efficiency of the system. Furthermore, FIG. 3 shows human-face detection results utilizing the hardware units of the system 100 for identifying a human face applying to different scenarios. Wherein, ◯ represents that a human face on such input source can be detected, and × represents that a human face on such input source can not be detected. When a human face is on a color picture, a display unit of a smart phone/computer, the IR camera 120 and the non-contact temperature sensing device 130 may not detect such human face, such that the system 100 for identifying a human face may not be misled. In addition, when a human face is on an IR picture, the visible light camera 110 may not detect such human face with a skin-color detection function, and the non-contact temperature sensing device 130 may not detect such human face either, such that the system 100 for identifying a human face may not be misled by the human face on the IR picture. Furthermore, when a human face is faked utilizing a mask or a dummy model, the system 100 for identifying a human face may not be misled utilizing the non-contact temperature sensing device 130. In other words, the system 100 for identifying a human face of the present invention would not be misled by common methods for faking human faces, which leads that the system 100 for identifying a human face has a high identification accuracy.

In some embodiments of this invention, the processing unit 140 may further comprise a face identifying module 143 and a notification module 144. When the processing unit 140 determines that the human face detected in the corresponding zone is an alive human face, the face identifying module 143 may further identify the human face detected in the corresponding zone. Wherein, the face identifying module 143 may perform the face identification to the corresponding zone of at least one of the visible-light picture and the IR picture. Therefore, the system 100 for identifying a human face of the present invention would not be misled by common methods for faking human faces, which enhances identification reliability of the system 100 for identifying a human face.

In addition, when the processing unit 140 determines that the human face detected in the corresponding zone is not an alive human face, the notification module 144 generates a notification message to notice a position of the temperature sensing zone which can be sensed by the non-contact temperature sensing device 130. The notification message can be a voice message, a light message, a word message, any other type of message or combination thereof. Therefore, a user can move his/her face to the correct temperature sensing zone, which can be sensed by the non-contact temperature sensing device 130.

In another embodiment of this invention, the processing unit 140 further includes an instruction executing module 145. Hence, when processing unit 140 determines that the human face detected in the corresponding zone is an alive human face, the instruction executing module 145 starts to execute a preset instruction. For example, when the system 100 for identifying a human face is applied to a digital signage machine, the instruction executing module 145 may start to execute a preset instruction for displaying advertisement when an alive human face is detected in the corresponding zone. In other embodiments, the instruction executing module 145 may start to execute any other preset instruction when an alive human face is detected in the corresponding zone, which should not be limited in this disclosure. Therefore, number of executed instruction in vain due to non-alive human face can be reduced.

In some embodiments of this invention, the system 100 for identifying a human face may further include spectroscopes (not shown). The spectroscopes can split light from the same photograph zone to the visible light camera 110 and the IR camera 120. Hence, the visible light camera 110 and the IR camera 120 aim at a same photograph zone for photographing through a light splitting function of the spectroscopes.

In another embodiment of this invention, the visible light camera 110 and the IR camera 120 may be implemented utilizing a same sensor. The visible light camera 110 may include a visible light filter, and the IR camera 120 may include an IR filter. Hence, the visible light camera 110 and the IR camera 120 utilize a same sensor to respectively photograph the visible-light picture and the IR picture through the visible light filter and the IR filter. Hence, the number of the sensors needed may be reduced, which can decrease the cost.

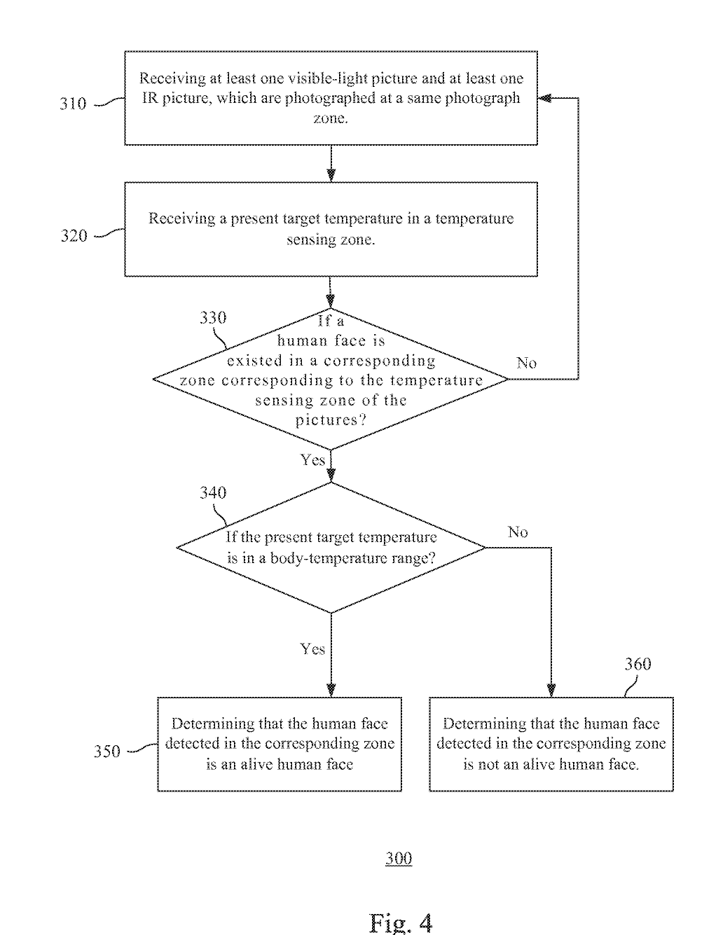

Referring to FIG. 4, a flow diagram will be described that illustrates a method for identifying a human face according to one embodiment of this invention. The method for identifying a human face may take the form of a computer program product stored on a non-transitory computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives.

The method 300 for identifying a human face includes the following steps:

At step 310, at least one visible-light picture and at least one IR picture, which are photographed at a same photograph zone, are received.

At step 320, a present target temperature in a temperature sensing zone is received. Wherein, the temperature sensing zone is in the photograph zone. In addition, the visible-light picture, the IR picture and the present target temperature may be photographed or sensed at exactly or almost the same time.

At step 330, if a human face is existed in a corresponding zone corresponding to the temperature sensing zone of the visible-light picture and that of the IR picture is respectively detected. If at least one of the visible-light picture and the IR picture does not exist a human face, next visible-light picture and IR picture may be received (step 310). In some embodiments of this invention, a human-face detecting algorithm or a human-face identifying algorithm may be performed to the visible-light picture and the IR picture to detect if a human face is existed in the corresponding zone of the pictures (step 330). In some other embodiments of this invention, a skin-color detection may be performed to the corresponding zone corresponding to the temperature sensing zone of the visible-light picture for determining if a skin color zone which may be taken as a human face is existed in the corresponding zone for detection at step 330.

At step 340, when it is detected that a human face is existed in the corresponding zone of the visible-light picture and that of the IR picture, if the present target temperature is in a body-temperature range is determined.

At step 350, when the present target temperature is in the body-temperature range, it is determined that the human face detected in the corresponding zone is an alive human face. Therefore, pictures with human faces, human faces displayed on display units, human-face masks or other methods for faking human faces would not be determined as alive human faces. In addition, only one single visible picture and one single IR picture are needed for an alive-human-face determination, which can speed up identification efficiency.

At step 360, when the present target temperature is not in the body-temperature range, it is determined that the human face detected in the corresponding zone is not an alive human face.

In some embodiments of this invention, when it is determined that the human face detected in the corresponding zone is an alive human face (step 350), the human face detected in the corresponding zone may be further identified. Therefore, identification would not be misled by common methods for faking human faces, which enhances identification reliability.

In addition, when it is determined that the human face detected in the corresponding zone is not an alive human face (step 360), a notification message may be generated to notice a position of the temperature sensing zone for sensing the present target temperature. The notification message can be a voice message, a light message, a word message, any other type of message or combination thereof. Therefore, a user can move his/her face to the correct temperature sensing zone for sensing the present target temperature.

In another embodiment of this invention, when it is determined that the human face detected in the corresponding zone is an alive human face (step 350), start to execute a preset instruction. For example, when the present invention is applied to a digital signage machine, the digital signage machine may start to execute a preset instruction for displaying advertisement when an alive human face is detected in the corresponding zone. In other embodiments, any other preset instruction may be started to be execute when an alive human face is detected in the corresponding zone, which should not be limited in this disclosure. Therefore, number of executed instruction in vain due to non-alive human face can be reduced.

In some embodiments of this invention, spectroscopes can split light from the same photograph zone to a visible light camera and an IR camera for respectively photographing the visible-light picture and the IR picture for receiving at step 310. Hence, the visible light camera and the IR camera can aim at a same photograph zone for photographing through a light splitting function of the spectroscopes.

In some other embodiments, a same sensor may be utilized to respectively photograph the visible-light picture and the IR picture through a visible light filter and an IR filter. Hence, the number of the sensors needed may be reduced, which can decrease the cost.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A system for identifying a human face comprising:
a visible light camera configured to photograph at least one visible-light picture;
an infrared (IR) camera configured to photograph at least one IR picture, wherein the visible light camera and the IR camera aim at a same photograph zone for respectively photographing the visible-light picture and the IR picture;
a non-contact temperature sensing device configured to sense a present target temperature in a temperature sensing zone, wherein the temperature sensing zone is in the photograph zone; and
a processing unit, building connections with the visible light camera, the IR camera and the non-contact temperature sensing device, wherein the processing unit comprises:
a face detecting module configured to detect if a human face is existed in a corresponding zone corresponding to the temperature sensing zone of the visible-light picture and that of the IR picture respectively; and
a body-temperature determining module configured to determine if the present target temperature is in a body-temperature range when it is detected that a human face is existed in the corresponding zone of the visible-light picture and that of the IR picture, wherein when the present target temperature is in the body-temperature range, the processing unit determines that the human face detected in the corresponding zone is an alive human face.

2. The system for identifying a human face of claim 1 further comprising:
spectroscopes, wherein the visible light camera and the IR camera aim at the same photograph zone for photographing through a light splitting function of the spectroscopes.

3. The system for identifying a human face of claim 1, wherein:
the visible light camera comprises a visible light filter;
the IR camera comprises an IR filter; and
the visible light camera and the IR camera utilize a same sensor to respectively photograph the visible-light picture and the IR picture through the visible light filter and the IR filter.

4. The system for identifying a human face of claim 1, wherein the processing unit further comprises:
a face identifying module configured to identify the human face detected in the corresponding zone when the processing unit determines that the human face detected in the corresponding zone is an alive human face; and
a notification module configured to generate a notification message to notice a position of the temperature sensing zone when the processing unit determine that the human face detected in the corresponding zone is not an alive human face.

5. The system for identifying a human face of claim 1, wherein the processing unit further comprises:
an instruction executing module configured to start to execute a preset instruction when the processing unit determines that the human face detected in the corresponding zone is an alive human face.

6. A method for identifying a human face comprising:
(a) receiving at least one visible-light picture and at least one IR picture, which are photographed at a same photograph zone;
(b) receiving a present target temperature in a temperature sensing zone, which is in the photograph zone;
(c) detecting if a human face is existed in a corresponding zone corresponding to the temperature sensing zone of the visible-light picture and that of the IR picture respectively;
(d) when it is detected that a human face is existed in the corresponding zone of the visible-light picture and that of the IR picture, determining if the present target temperature is in a body-temperature range; and
(e) when the present target temperature is in the body-temperature range, determining that the human face detected in the corresponding zone is an alive human face.

7. The method for identifying a human face comprising of claim 6, wherein a visible light camera and a IR camera aim at the same photograph zone for photographing the visible-light picture and the IR picture through a light splitting function of spectroscopes.

8. The method for identifying a human face comprising of claim 6, wherein a same sensor is utilized to photograph the visible-light picture and the IR picture respectively through a visible light filter and an IR filter.

9. The method for identifying a human face comprising of claim 6 further comprising:
when it is determined that the human face detected in the corresponding zone is an alive human face, identifying the human face detected in the corresponding zone; and
when it is determined that the human face detected in the corresponding zone is not an alive human face, generating a notification message to notice a position of the temperature sensing zone.

10. The method for identifying a human face comprising of claim 6 further comprising:
when it is determined that the human face detected in the corresponding zone is an alive human face, starting to execute a preset instruction.
